(19) United States
(12) Patent Application Publication
(10) Pub. No.: US 2020/0151241 A1
(43) Pub. Date: May 14, 2020

(54) WEBPAGE COMPONENT REPLICATION SYSTEM AND METHOD

(71) Applicant: International Business Machines Corporation, Armonk, NY (US)

(72) Inventors: Keerthi Samireddy, Visakhapatnam (IN); Lakshmi Soumya Suggala, Visakhapatnam (IN); Mohammad Shajid, Visakhapatnam (IN)

(21) Appl. No.: 16/190,469

(22) Filed: Nov. 14, 2018

(51) Int. Cl. G06F 17/22; G06F 3/0486

(52) U.S. Cl. CPC G06F 17/2247; G06F 3/0486

(57) ABSTRACT

A method, computer program product, and computing system device for receiving a selection of at least a portion of a webpage. Code associated with the selected portion of the webpage may be extracted. Network traffic associated with the selected portion of the webpage may be monitored. One or more webpage components may be generated based upon, at least in part, the extracted code and the monitored network traffic associated with the selected portion of the webpage.

### BACKGROUND

Clients are expecting quicker and more frequent changes in web applications and components within web applications and mobile applications. Generating components often requires a great deal of technical skills such as knowledge in markup languages, graphic design methodologies, etc. However, many clients may not have access to individuals with sufficient technical skill to quickly and consistently provide new components such as webpage components. Additionally, many clients may desire to replicate certain features of existing webpage components but may have difficulty in replicating those individual features in new webpage components.

### BRIEF SUMMARY OF DISCLOSURE

In one example implementation, a computer-implemented method is executed on a computing device and may include but is not limited to receiving, on a computing device, a selection of at least a portion of a webpage. Code associated with the selected portion of the webpage may be extracted. Network traffic associated with the selected portion of the webpage may be monitored. One or more webpage components may be generated based upon, at least in part, the extracted code and the monitored network traffic associated with the selected portion of the webpage.

One or more of the following example features may be included. The at least a portion of the webpage may be selected. The selected portion of the webpage may be dragged to a droppable area within a user interface. Receiving the selection of the at least a portion of the webpage may include receiving architectural information associated with one or more webpage components. A webpage component associated with the at least a portion of the webpage may be visually recognized via a visual recognition system. One or more suggestions for similar webpage components may be provided based upon, at least in part, visually recognizing the webpage component associated with the selected portion of the webpage. Extracting code associated with the selected portion of the webpage may include extracting markup code associated with the selected portion of the webpage. Monitoring the network traffic associated with the selected portion of the webpage may include monitoring one or more server-side requests and one or more server-side responses associated with the selected portion of the webpage.

In another example implementation, a computer program product resides on a non-transitory computer readable medium that has a plurality of instructions stored on it. When executed across one or more processors, the plurality of instructions cause at least a portion of the one or more processors to perform operations that may include but are not limited to receiving, on a computing device, a selection of at least a portion of a webpage. Code associated with the selected portion of the webpage may be extracted. Network traffic associated with the selected portion of the webpage may be monitored. One or more webpage components may be generated based upon, at least in part, the extracted code and the monitored network traffic associated with the selected portion of the webpage.

One or more of the following example features may be included. The at least a portion of the webpage may be selected. The selected portion of the webpage may be dragged to a droppable area within a user interface. Receiving the selection of the at least a portion of the webpage may include receiving architectural information associated with one or more webpage components. A webpage component associated with the at least a portion of the webpage may be visually recognized via a visual recognition system. One or more suggestions for similar webpage components may be provided based upon, at least in part, visually recognizing the webpage component associated with the selected portion of the webpage. Extracting code associated with the selected portion of the webpage may include extracting markup code associated with the selected portion of the webpage. Monitoring the network traffic associated with the selected portion of the webpage may include monitoring one or more server-side requests and one or more server-side responses associated with the selected portion of the webpage.

In another example implementation, a computing system may include one or more processors and one or more memories, wherein the computing system is configured to perform operations that may include but are not limited to receiving, on a computing device, a selection of at least a portion of a webpage. Code associated with the selected portion of the webpage may be extracted. Network traffic associated with the selected portion of the webpage may be monitored. One or more webpage components may be generated based upon, at least in part, the extracted code and the monitored network traffic associated with the selected portion of the webpage.

One or more of the following example features may be included. The at least a portion of the webpage may be selected. The selected portion of the webpage may be dragged to a droppable area within a user interface. Receiving the selection of the at least a portion of the webpage may include receiving architectural information associated with one or more webpage components. A webpage component associated with the at least a portion of the webpage may be visually recognized via a visual recognition system. One or more suggestions for similar webpage components may be provided based upon, at least in part, visually recognizing the webpage component associated with the selected portion of the webpage. Extracting code associated with the selected portion of the webpage may include extracting markup code associated with the selected portion of the webpage. Monitoring the network traffic associated with the selected portion of the webpage may include monitoring one or more server-side requests and one or more server-side responses associated with the selected portion of the webpage.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE SEVERAL VIEWS OF THE DRAWINGS

FIG. 1 is an example diagrammatic view of webpage component replication process coupled to a distributed computing network according to one or more example implementations of the disclosure;

FIG. 2 is an example flowchart of the webpage component replication process of FIG. 1 according to one or more example implementations of the disclosure;

FIG. 3 is an example diagrammatic view of a webpage from which a user may select a portion to replicate according to one or more example implementations of the disclosure;

FIG. 4 is an example diagrammatic view of a user interface in which a user may select a portion to replicate and/or may provide architectural information according to one or more example implementations of the disclosure;

FIG. 5 is an example diagrammatic view of a website including a replica webpage component generated according to one or more example implementations of the disclosure; and

FIG. 6 is an example diagrammatic view of a client electronic device of FIG. 1 according to one or more example implementations of the disclosure.

Like reference symbols in the various drawings indicate like elements.

### DETAILED DESCRIPTION

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

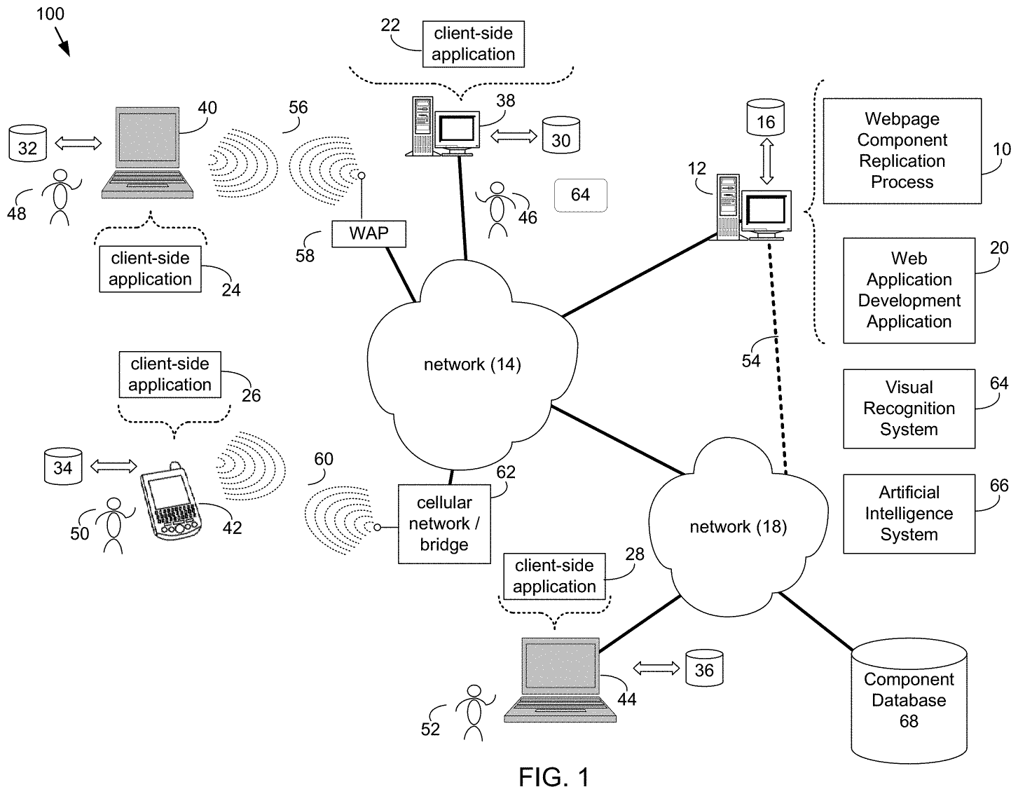

Referring now to FIG. 1, there is shown webpage component replication process 10 that may reside on and may be executed by a computing device 12, which may be connected to a network (e.g., network 14) (e.g., the internet or a local area network). Examples of computing device 12 (and/or one or more of the client electronic devices noted below) may include, but are not limited to, a personal computer(s), a laptop computer(s), mobile computing device(s), a server computer, a series of server computers, a mainframe computer(s), or a computing cloud(s). Computing device 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

As will be discussed below in greater detail, a webpage component replication process, such as webpage component replication process 10 of FIG. 1, may receive, on a computing device, a selection of at least a portion of a webpage. Code associated with the selected portion of the webpage may be extracted. Network traffic associated with the selected portion of the webpage may be monitored. One or more webpage components may be generated based upon, at least in part, the extracted code and the monitored network traffic associated with the selected portion of the webpage.

The instruction sets and subroutines of webpage component replication process 10, which may be stored on storage device 16 coupled to computing device 12, may be executed by one or more processors (not shown) and one or more memory architectures (not shown) included within computing device 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

Webpage component replication process 10 may be a stand-alone application that interfaces with an applet/application that is accessed via client applications 22, 24, 26, 28, 66. In some embodiments, webpage component replication process 10 may be, in whole or in part, distributed in a cloud computing topology. In this way, computing device 12 and storage device 16 may refer to multiple devices, which may also be distributed throughout network 14 and/or network 18.

Computing device 12 may execute a web application development application. Web application development application may generally include any application used to develop websites, webpages, web components for websites and webpages. Web application development applications may also generally include applications for developing mobile applications and other applications accessible to computing devices. Webpage component replication process 10 and/or web application development application 20 may be accessed via client applications 22, 24, 26, 28, 66. Webpage component replication process 10 may be a stand-alone application, or may be an applet/application/script/extension that may interact with and/or be executed within web application development application 20, a component of web application development application 20, and/or one or more of client applications 22, 24, 26, 28, 66. Web application development application 20 may be a stand-alone application, or may be an applet/application/script/extension that may interact with and/or be executed within webpage component replication process 10, a component of webpage component replication process 10, and/or one or more of client applications 22, 24, 26, 28, 66. One or more of client applications 22, 24, 26, 28, 66 may be a stand-alone application, or may be an applet/application/script/extension that may interact with and/or be executed within and/or be a component of webpage component replication process 10 and/or web application development application 20. Examples of client applications 22, 24, 26, 28, 66 may include, but are not limited to, applications that receive queries to search for content from one or more databases, servers, cloud storage servers, etc., a textual and/or a graphical user interface, a customized web browser, a plugin, an Application Programming Interface (API), or a custom application. The instruction sets and subroutines of client applications 22, 24, 26, 28, 66 which may be stored on storage devices 30, 32, 34, 36, coupled to client electronic devices 38, 40, 42, 44 may be executed by one or more processors (not shown) and one or more memory architectures (not shown) incorporated into client electronic devices 38, 40, 42, 44.

Storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computing device 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet (not shown), a server (not shown), a television (not shown), a smart television (not shown), a media (e.g., video, photo, etc.) capturing device (not shown), and a dedicated network device (not shown). Client electronic devices 38, 40, 42, 44 may each execute an operating system, examples of which may include but are not limited to, Microsoft® Windows®; Mac® OS X®; Red Hat® Linux®, Windows® Mobile, Chrome OS, Blackberry OS, Fire OS, or a custom operating system.

One or more of client applications 22, 24, 26, 28, 66 may be configured to effectuate some or all of the functionality of webpage component replication process 10 (and vice versa). Accordingly, webpage component replication process 10 may be a purely server-side application, a purely client-side application, or a hybrid server-side/client-side application that is cooperatively executed by one or more of client applications 22, 24, 26, 28, 66 and/or webpage component replication process 10.

One or more of client applications 22, 24, 26, 28, may be configured to effectuate some or all of the functionality of web application development application 20 (and vice versa). Accordingly, web application development application 20 may be a purely server-side application, a purely client-side application, or a hybrid server-side/client-side application that is cooperatively executed by one or more of client applications 22, 24, 26, 28 and/or web application development application 20. As one or more of client applications 22, 24, 26, 28, webpage component replication process 10, and web application development application 20, taken singly or in any combination, may effectuate some or all of the same functionality, any description of effectuating such functionality via one or more of client applications 22, 24, 26, 28, webpage component replication process 10, web application development application 20, or combination thereof, and any described interaction(s) between one or more of client applications 22, 24, 26, 28, webpage component replication process 10, web application development application 20, or combination thereof to effectuate such functionality, should be taken as an example only and not to limit the scope of the disclosure.

Users 46, 48, 50, 52 may access computing device 12 and webpage component replication process 10 (e.g., using one or more of client electronic devices 38, 40, 42, 44) directly or indirectly through network 14 or through secondary network 18. Further, computing device 12 may be connected to network 14 through secondary network 18, as illustrated with phantom link line 54. Webpage component replication process 10 may include one or more user interfaces, such as browsers and textual or graphical user interfaces, through which users 46, 48, 50, 52 may access webpage component replication process 10.

The various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 800.11a, 800.11b, 800.11g, Wi-Fi®, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown directly coupled to network 14.

Some or all of the IEEE 800.11x specifications may use Ethernet protocol and carrier sense multiple access with collision avoidance (i.e., CSMA/CA) for path sharing. The various 800.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

In some implementations and as will be discussed in greater detail below, client electronic devices may interact with a visual recognition system (e.g., visual recognition system 64), an artificial intelligence system (e.g., artificial intelligence system 66), and/or a component database (e.g., component database 68) communicatively coupled to network 18.

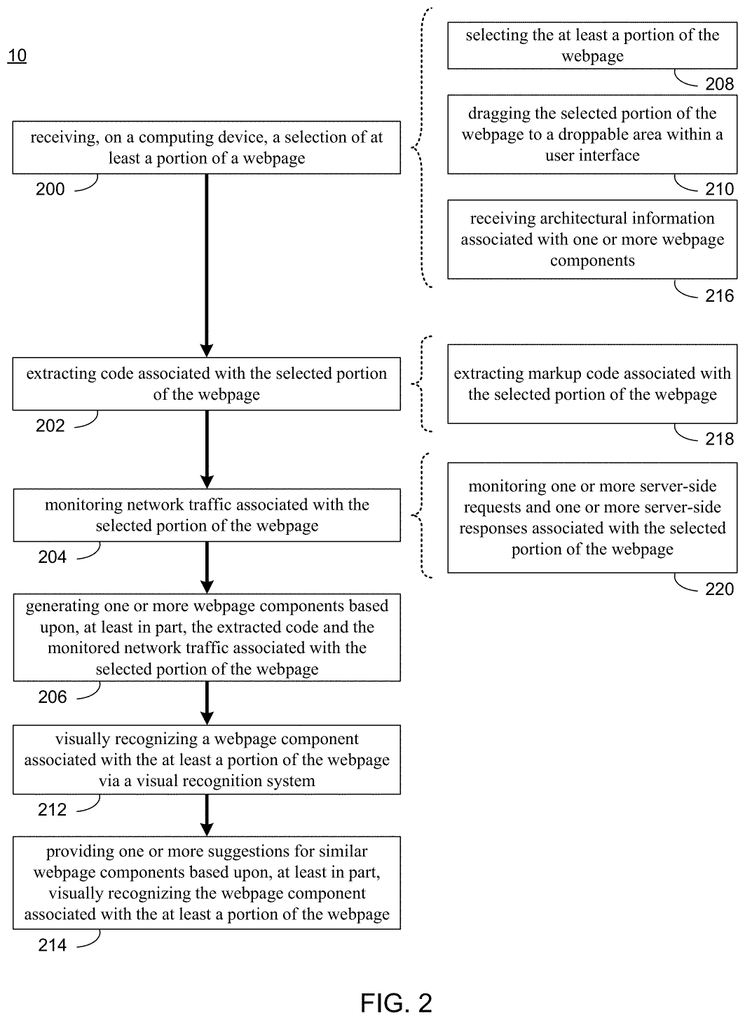

As discussed above and referring also at least to FIGS. 2-6, webpage component replication process 10 may receive 200, on a computing device, a selection of at least a portion of a webpage. Code associated with the selected portion of the webpage may be extracted 202. Network traffic associated with the selected portion of the webpage may be monitored 204. One or more webpage components may be generated 206 based upon, at least in part, the extracted code and the monitored network traffic associated with the selected portion of the webpage.

In some implementations consistent with the present disclosure, systems and methods may be provided for replicating webpage components. As discussed above, in this agile world, clients may often expect quick and frequent changes in web applications. Generating webpage components often requires a great deal of technical skills such as knowledge in markup languages, graphic design methodologies etc. However, many clients may not have access to individuals with sufficient technical skill to quickly and consistently provide new webpage components. Additionally, many clients may desire to replicate certain features of existing webpage components but may have difficulty in replicating those individual features in new webpage components. To overcome these challenges, embodiments of the present disclosure may receive any kind of web content or HTML entities. Source code may be exported later unlike making use of limited and pre-defined templates in conventional webpage template systems.

Embodiments of the present disclosure can receive a plurality of options, features, pre-stored webpage components or webpage models, HTML formatting code, options, text, fields, formulas, etc. From these stored models of webpage components, embodiments of the present disclosure may obtain any kind of web content or HTML entities into a customized web application with the help of source code exportability features. The webpage components or webpage models may correspond to different types of web pages and other features commonly found from accessing various web sites. For example and as will be discussed in greater detail below, various features for customization of webpage components may be obtained with the help of user actions and/or navigation on a desired webpage component. Embodiments of the present disclosure may also include a dynamic look-up capability to automatically populate one or more fields incorporating personalized and customized data. This may minimize or eliminate the need for a web site creator to know or use HTML or other programming languages to create a web site enabling personalization and customization of the web site and pages. For example, personalized data may be pulled out from database which may maintain the user's activity. For example, social media data, adhering to General Data Protection Regulation (GDPR) guidelines, networking sites or employment-oriented services or the data collected with user's consent may be automatically populated into portions of webpage components.

In some implementations, webpage component replication process 10 may interact with and/or communicate with a webpage, a website, mobile application, or other computer application editing software for generating webpages, website, mobile applications, etc. As discussed above, the ability to quickly generate new components or models for webpages and/or mobile applications may require extensive coding knowledge. Many webpage developers may be unable to quickly generate these new components or models and/or may lack the requisite knowledge. Accordingly, embodiments of the present disclosure may allow a user to identify components or models from webpages, mobile applications, or any other computer application to generate a replica of those identified components or models. In some implementations and as will be discussed in greater detail below, webpage component replication process 10 may utilize machine learning and artificial intelligence to visually recognize webpage components for replicating and may provide suggestions to a user to further enhance component or model functionality.

While several examples throughout the present disclosure may refer to “webpage components” or “webpage models”, these are for exemplary purposes and do not limit the scope of the present disclosure. For example, mobile application or other computer application models or components may be replicated within the scope of the present disclosure. A component or model may include a structural portion or feature that defines at least a portion of webpage, a website, mobile application, or other computer application. For example, a component may include a calendar component with a reminder functionality that is configured to display at least a portion of a calendar (e.g., days, months, years, etc.). As discussed above, a user may desire to “replicate” models or components. However, replication as used herein generally refers to generating an exact copy of a model or component as well as a copy of a model or component that includes similar features but is not an exact copy. For example and as will be discussed in greater detail below, a user may desire to insert a particular model or component (e.g., a calendar application with a reminder function) into a webpage. Webpage component replication process 10 may determine that the desired model is a calendar application and may provide suggestions for similar calendar applications with various features. The user may select certain suggested features. Accordingly, webpage component replication process 10 may generate a “replica” webpage component with similar features. As such, the generated webpage component may not be an exact copy but may share various similarities.

In some implementations, webpage component replication process 10 may receive 200, on a computing device, a selection of at least a portion of a webpage. In some implementations, webpage component replication process 10 may provide various methodologies for receiving a selection of webpage to accommodate users with varying technical knowledge. For example, webpage component replication process 10 may provide a user interface with one or more ways of receiving a selection of at least a portion of a webpage or webpage component. In some implementations, webpage component replication process 10 may receive a webpage component by allowing the user to interact with a webpage component. For example, a user (e.g., user 36) may be developing a website and searching for e.g., user interface components on the Internet. During the user's searching, the user may view a first webpage and may then navigate to a second webpage. From the second webpage, the user may navigate to a third webpage and so on. In some implementations, when the user sees a portion of a webpage or webpage component of interest, the user may desire to implement the same, and/or similar, webpage component on the user's webpage. In an example embodiment, webpage component replication process 10 may allow the user to select the webpage component and generate a replica of the desired webpage component or portion of a webpage.

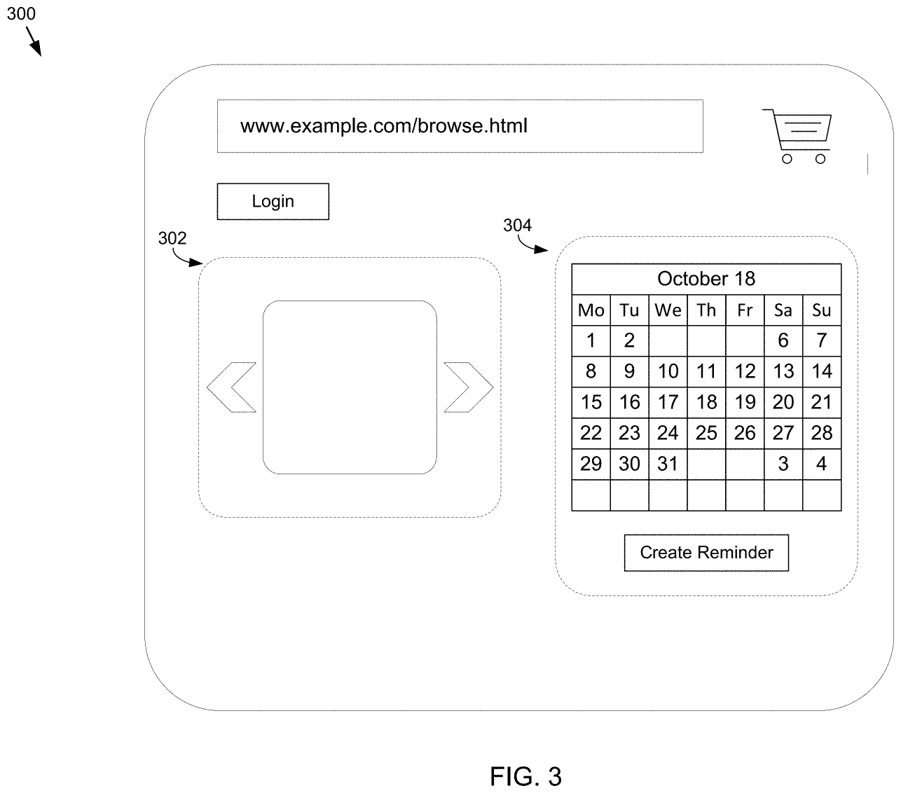

For example, webpage component replication process 10 may receive a command (e.g., button selection within a user interface, a voice command, code execution in a command prompt or other code execution system, etc.) for webpage component replication process 10 to capture subsequent user actions on a webpage, website, mobile application, etc. Referring also to the example of FIG. 3 and in some implementations, a user (e.g., user 36) may select a button in a user interface to command or direct webpage component replication process 10 to capture or otherwise record the user's actions and/or navigation on a webpage (e.g., webpage 300). In response to this command, webpage component replication process 10 may prompt the user (e.g., via one or more pop-up windows, lines in a command prompt, etc.) to explore or otherwise interact with a webpage component or webpage model. In this manner and as will be discussed in greater detail below, webpage component replication process 10 may receive 200 at least a portion of the webpage by the user navigating a website and capturing the portion(s) of the webpage accessed and/or utilized by the user.

In some implementations, receiving 200 the at least a portion of the webpage may include selecting 208 the at least a portion of the webpage. For example, a user may interact with a webpage component (i.e., slideshow component 302). By interacting with this webpage component, webpage component replication process 10 may select 208 the webpage component for replicating. As the user interacts with the webpage component, webpage component replication process 10 may record or otherwise capture the user's actions. In some implementations, the user may select 208 the webpage component for replicating. For example, webpage component replication process 10 may provide a pop-up window with options to replicate a particular portion of the webpage or webpage component.

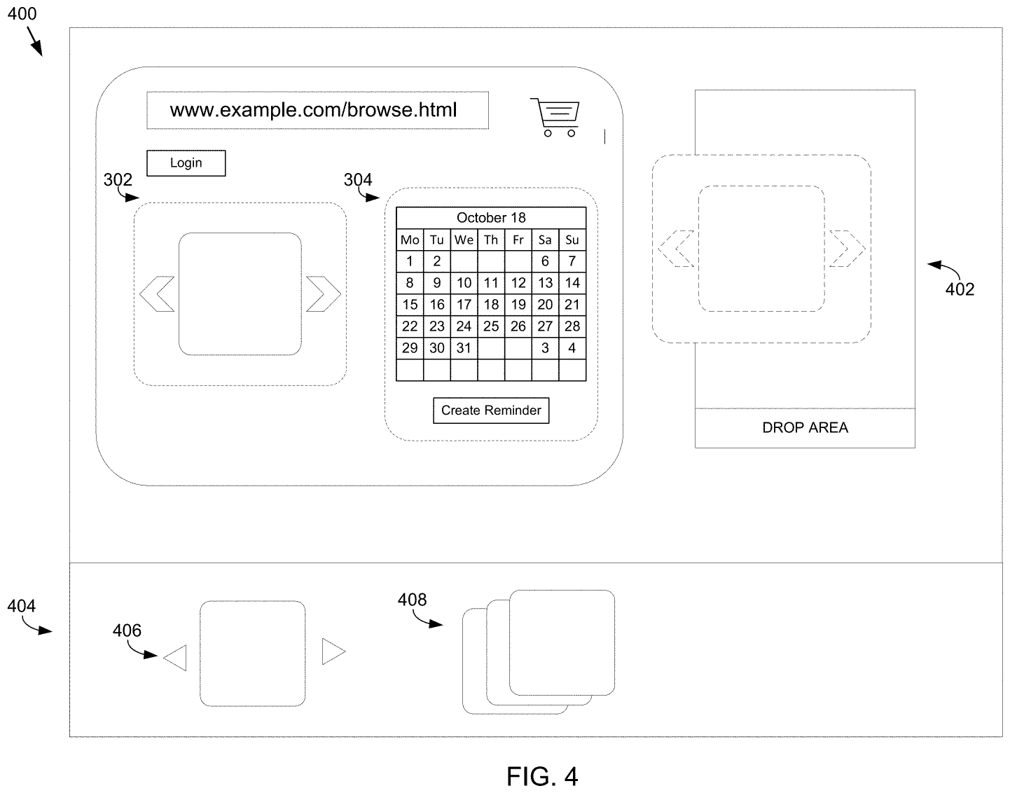

In some implementations, receiving 200 the at least a portion of the webpage may include dragging 210 the selected portion of the webpage to a droppable area within a user interface. Referring also to the example of FIG. 4 and in some implementations, webpage component replication process 10 may provide a user interface (e.g., user interface 400) with a “drop” area (e.g., drop area 402) or portion of a user interface for receiving the selected 208 portions of the webpage. For example, a user may select 208 a webpage component (e.g., slideshow component 302) from a webpage (e.g., webpage 300) and may drag or otherwise move the selected webpage component to the drop area (e.g., drop area 402). In this manner, webpage component replication process 10 may provide an interface to drag and drop a stored/dynamically generated component. For example, webpage component replication process 10 may provide a user interface which may take inputs and accordingly generate a draggable mirror component. The user can then drag the component and drop it into the drop area (e.g., drop area 402). This drag and drop functionality may assist webpage component replication process 10 by specifying which component or model the user would like to replicate. For example, a user may interact with several components or models but may only be interested in a subset of the components or models interacted with. As discussed above, this may enable users with lower coding knowledge to be able to select webpage components for replicating by selecting webpage components from a webpage by interacting with them (e.g., dragging and dropping into the drop area) rather than attempting to decipher various components from underlying code of a webpage or application.

In some implementations, webpage component replication process 10 may visually recognize 212 a webpage component associated with the at least a portion of the webpage via a visual recognition system. For example, webpage component replication process 10 may receive an image of the at least a portion of the webpage (e.g., a screenshot or photograph). For example and in some implementations, webpage component replication process 10 may receive an image from e.g., a mobile device and may visually recognize 212 a webpage component in the image. In some implementations, the user may scan at least a portion of a website using a computing device and the scanned portion of the website may be processed by a visual recognition system to visually recognize one or more webpage components in the scanned portion of the website.

In some implementations, webpage component replication process 10 may visually recognize 212 the webpage component that is dragged 208 and dropped into the drop area (e.g., drop area 402). Visual recognition may generally include the use of machine learning algorithms and artificial intelligence engines to process an image of the webpage component and may be performed using a visual recognition system (e.g., visual recognition system 64). Accordingly, webpage component replication process 10 may determine if the at least a portion of the webpage (e.g., selected webpage component) is sufficiently similar to a pre-defined webpage component. In this manner, webpage component replication process 10 may visually recognize a webpage component associated with the at least a portion of the webpage. A visual recognition system or visual recognition engine (e.g., visual recognition system 64), such as the IBM Watson™ Visual Recognition service, may be trained by providing one or more training images of various webpage components or models. It will be appreciated that any visual recognition engine may be used within the scope of the present disclosure.

For example, webpage component replication process 10 may receive an image of the at least a portion of the webpage and may process the image via the visual recognition system to determine if the at least a portion of the webpage may be recognized as one or more pre-defined webpage components. In some implementations, webpage component replication process 10 may generate and maintain a database of pre-defined webpage components (e.g., component database 68). In some implementations, webpage component replication process 10 may communicate with publicly available repository application program interfaces (APIs) such as GitHub™ and other repositories of webpage components or models.

In some implementations, webpage component replication process 10 may provide 214 one or more suggestions for similar webpage components based upon, at least in part, visually recognizing the webpage component associated with the at least a portion of the webpage (e.g., the selected portion of the webpage). In some implementations, webpage component replication process 10 may visually recognize 212 a selected portion of a webpage or webpage component and may provide one or more suggestions for similar webpage components. For example, suppose a user selects a calendar webpage component on a website (e.g., using any of the methodologies discussed above). Webpage component replication process 10 may visually recognize the selected webpage component as a calendar webpage component based upon, at least in part, one or more pre-defined webpage components stored in a webpage component database and/or a publicly available repository. In response to visually recognizing 212 the webpage component, webpage component replication process 10 may provide 214 one or more recommendations or suggestions for similar webpage components. In some implementations, the similar webpage components provided 214 by webpage component replication process 10 may include webpage components with additional features, webpages components built with industry best standards or webpage components that provide industry best recommended coding standards (e.g., W3 Consortium standards), webpage components that match the functionality of a selected webpage component but are written using a different programming language, etc.

In some implementations, webpage component replication process 10 may provide 214 the one or more suggestions for similar webpage components in a user interface via e.g., a pop-up window, a table of similar webpage components, etc. In some implementations, these suggestions for webpage components may be recommended using analytical and predictive capabilities of artificial intelligence systems (artificial intelligence system 66). From these provided suggestions for webpage components, a user may select a desired webpage component. In some implementations, a user may not select any of the proposed similar webpage components. For example, suppose a user was presented with one or more similar calendar webpage components. In this example, suppose the user did not want any of these similar calendar options but wanted a replica of the selected webpage component. In this manner, webpage component replication process 10 may allow a user to ignore the one or more suggested webpage components and choose to generate a replica of the webpage component selected by the user.

Referring again to the example of FIG. 4, webpage component replication process 10 may provide 214 the one or more suggestions for similar webpage components in a user interface (e.g., window 404). In some implementations, a user may select (e.g., with a cursor, voice command, etc.) one or more suggested similar webpage components based upon, at least in part, visually recognizing the selected portion of the webpage and/or receiving architectural information associated with one or more webpage components (as will be discussed in greater detail below). For example, a user may be provided 214 with one or more suggestions for similar webpage components (e.g., slideshow components 406, 408). While two similar webpage components are shown in FIG. 4, it will be appreciated that any number of suggestions may be given within the scope of the present disclosure.

As discussed above, webpage component replication process 10 may receive 200 at least a portion of website for replicating from users with varying technical (e.g., coding) abilities by allowing a user to navigate a webpage and capturing webpage components, selecting and dragging components into a drop area, and/or scanning at least a portion of a webpage. These features may help address the case where a user has little to no experience in coding webpage components. In some implementations, webpage component replication process 10 may also provide more experienced users with the ability to provide architectural information associated with one or more webpage components. Architectural information may generally include user-defined specifications for webpage components such as programming language, language context feed, in-memory database of classes, variable names, methods, constructs, packages, etc. In this manner, webpage component replication process 10 may receive 216 architectural information associated with one or more webpage components. Referring again to the example of FIG. 4 and in some implementations, webpage component replication process 10 may provide input fields for language context feed, in-memory database of classes, variable names, methods and other constructs or packages, etc. that are specific to a particular programming language. In this manner, webpage component replication process 10 may receive 216 architectural information associated with one or more webpage components to customize webpage components per user specifications.

In some implementations, webpage component replication process 10 may provide suggestions for one or more webpage components based upon, at least in part, the architectural information received 216 from a user. For example, a user may provide architectural information associated with one or more webpage components. From the architectural information provided by the user, webpage component replication process 10 may provide suggestions for one or more similar webpages. For example, suppose a user provided architectural information for a webpage component with a particular method in the code of the webpage component and is specific to a particular programming language. From this architectural information and as discussed above, webpage component replication process 10 may provide suggestions for one or more similar webpage components that have similar methods and/or the exact same method and/or are written in the specified programming language. It will also be appreciated that webpage component replication process 10 may provide suggestions for one or more webpage components based upon, at least in part, a combination of architectural information and visually recognizing the at least a portion of the webpage or webpage component.

While the above examples have described certain methodologies for receiving a user's selection of a webpage component to replicate as being associated with a particular technical level or coding level of a user, it will be appreciated that users proficient in coding webpage components may utilize any of the methodologies discussed above. For example, a user proficient in coding may drag and drop a webpage component into a drop area and/or define architecture information. Similarly, it will be appreciated that a user novice in coding may provide architectural information to webpage component replication process 10 for customizing a webpage component to be generated. It will be appreciated that any of the above described methodologies for receiving 200 the at least a portion of a webpage may be used individually or in any combination within the scope of the present disclosure.

In some implementations, webpage component replication process 10 may extract 202 code associated with the selected portion of the webpage. For example, after selection of the at least a portion of the webpage (e.g., the selected webpage component and/or any suggested webpage components and/or suggested additional features), webpage component replication process 10 may compute one or more inputs required to build the desired model or component. In some implementations, webpage component replication process 10 may extract 202 code associated with the at least a portion of the webpage (e.g., the selected webpage component and/or any suggested webpage components and/or suggested additional features). In some implementations, extracting 202 the code associated with the selected portion of the webpage may include extracting 218 markup code associated with the selected portion of the webpage. For example, a model or component's markup code as well as corresponding scripts may be extracted 218 by using the script references associated in the extracted markup from the webpage or application page(s).

In some implementations, webpage component replication process 10 may monitor 204 network traffic associated with the selected portion of the webpage. For example, webpage component replication process 10 may monitor network traffic to define the inputs and outputs for the selected portion of the webpage. In some implementations, monitoring 204 the network traffic associated with the selected portion of the webpage may include monitoring 220 one or more server-side requests and one or more server-side responses associated with the selected portion of the webpage. In this manner, webpage component replication process 10 may check the requests and response of backend calls to simulate the selected webpage component's (e.g., the selected webpage component and/or any suggested webpage components and/or suggested additional features) inputs and/or outputs. In some implementations, webpage component replication process 10 may monitor client-side requests and client-side responses.

In some implementations, webpage component replication process 10 may generate 206 one or more webpage components based upon, at least in part, the extracted code and the monitored network traffic associated with the selected portion of the webpage. In some implementations, webpage component replication process 10 may generate code for the one or more replica webpage components based upon, at least in part, the extracted 202 code and the monitored 204 network traffic associated with the selected portion of the webpage. The generated code may be validated by webpage component replication process 10 using one or more code interpreters and/or code compilers. In some implementations and in response to validating the generated code for the one or more replica webpage components, webpage component replication process 10 may provide suggestions for constructing improvised logic/functionality and/or for optimizing existing logic/functionality. For example, webpage component replication process 10 may analyze available webpage components to make suggestions with respect to the user's specifications for webpage components, the user's previous recorded interactions with webpage components (e.g., a user's likes or comments or interest in a social media webpage component), contemporary webpage components, etc. In some implementations, webpage component replication process 10 may generate client-side code for the generated one or more replica webpage components but may also mimic business logic of the selected webpage component.

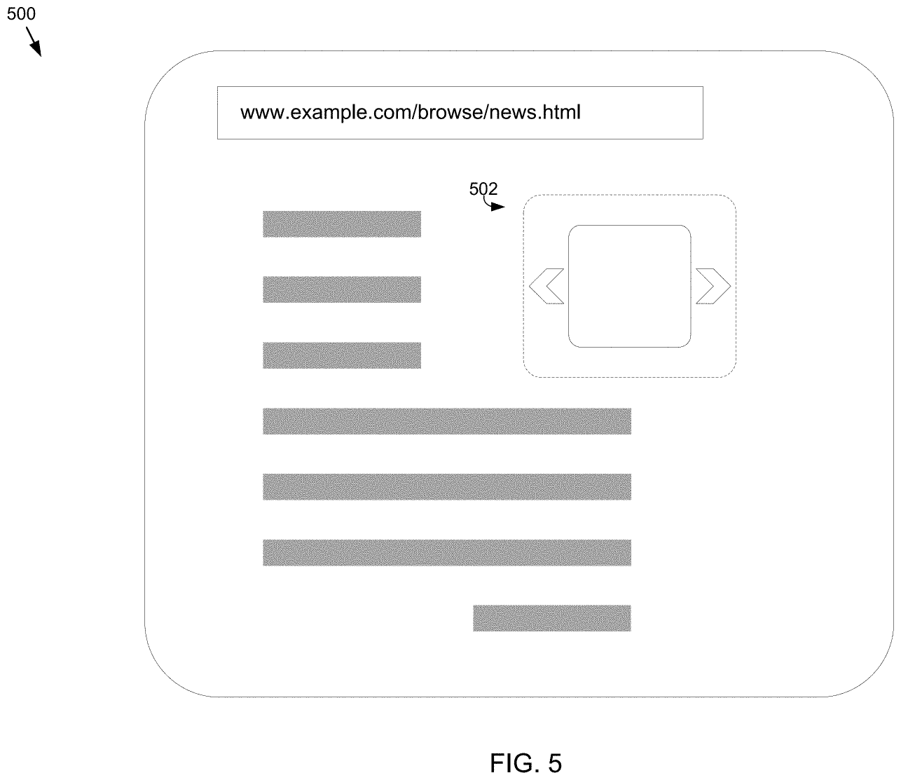

Referring also to example website (e.g., website 500) of FIG. 5 and in some implementations, webpage component replication process 10 may generate 206 a replica webpage component (e.g., replica slideshow component 502) for a user's website based upon, at least in part, the extracted 202 code and the monitored 204 network traffic associated with the selected portion of the webpage (e.g., slideshow component 302). In some implementations, webpage component replication process 10 may automatically include personalized data into the replicated webpage component (e.g., replicated slideshow component 502). For example, webpage component replication process 10 may identify images associated with a user's website (e.g., website 500) and add them to the replicated slideshow component. While images have been discussed, it will be appreciated that various kinds of personalized data may be automatically integrated into the replica webpage components.

In some implementations, webpage component replication process 10 may dynamically create new templates and store these new templates in the webpage component database (e.g., webpage component database). For example, webpage component replication process 10 may create a unique identifier (e.g., an alphanumerical sequence) specific to each generated webpage component. Using these unique identifiers, each webpage component may be stored in the webpage component database and may be recalled by a user when developing new webpages, websites, mobile applications, etc.

As discussed above, embodiments of the present disclosure may minimize or eliminate the need for a website creator to know or use HTML or other programming languages to create a website or webpage enabling personalization and customization of the web site and pages. In some implementations, webpage component replication process 10 may dynamically build or generate a component or model database from websites that can be extended to organizations, businesses, etc. In this manner, webpage component replication process 10 may leverage visual recognition systems and artificial intelligence systems to automatically generate webpage components from existing webpage components.

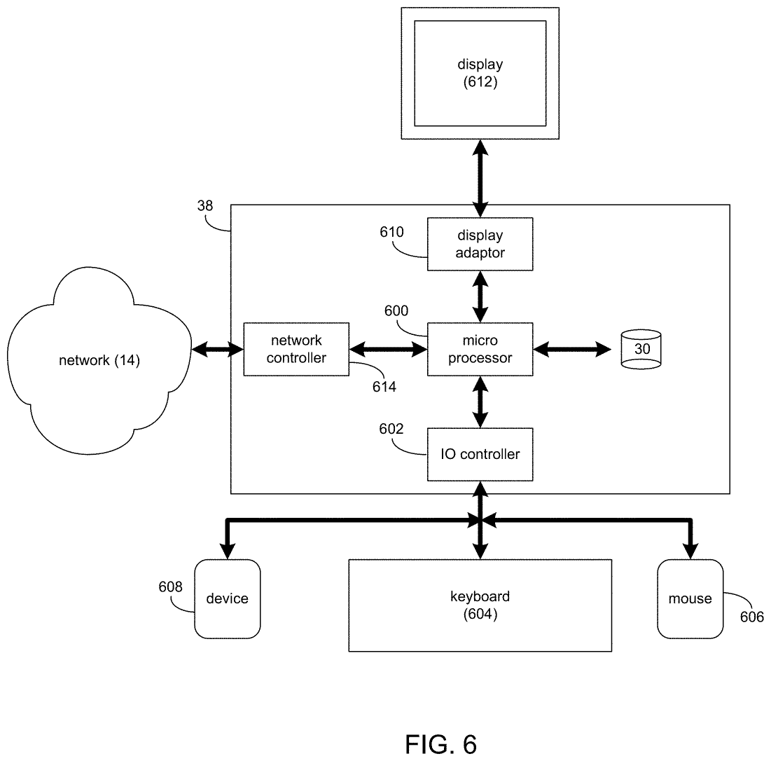

Referring also to FIG. 6, there is shown a diagrammatic view of client electronic device 38. While client electronic device 38 is shown in this figure, this is for illustrative purposes only and is not intended to be a limitation of this disclosure, as other configurations are possible. For example, any computing device capable of executing, in whole or in part, webpage component replication process 10 may be substituted for client electronic device 38 within FIG. 6, examples of which may include but are not limited to computing device 12 and/or client electronic devices 40, 42, 44.

Client electronic device 38 may include a processor and/or microprocessor (e.g., microprocessor 600) configured to, e.g., process data and execute the above-noted code/instruction sets and subroutines. Microprocessor 600 may be coupled via a storage adaptor (not shown) to the above-noted storage device(s) (e.g., storage device 30). An I/O controller (e.g., I/O controller 602) may be configured to couple microprocessor 600 with various devices, such as keyboard 604, pointing/selecting device (e.g., mouse 606), custom device, such a microphone (e.g., device 608), USB ports (not shown), and printer ports (not shown). A display adaptor (e.g., display adaptor 610) may be configured to couple display 612 (e.g., CRT or LCD monitor(s)) with microprocessor 600, while network controller/adaptor 614 (e.g., an Ethernet adaptor) may be configured to couple microprocessor 600 to the above-noted network 14 (e.g., the Internet or a local area network).

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents of all means or step plus function elements that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to best explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
receiving, on a computing device, a selection of at least a portion of a webpage;
extracting code associated with the selected portion of the webpage;
monitoring network traffic associated with the selected portion of the webpage; and
generating one or more webpage components based upon, at least in part, the extracted code and the monitored network traffic associated with the selected portion of the webpage.

2. The computer-implemented method of claim 1, wherein receiving the selection of the at least a portion of the webpage includes:
selecting the at least a portion of the webpage; and
dragging the selected portion of the webpage to a droppable area within a user interface.

3. The computer-implemented method of claim 1, wherein receiving the selection of the at least a portion of the webpage includes receiving architectural information associated with one or more webpage components.

4. The computer-implemented method of claim 1, further comprising:
visually recognizing a webpage component associated with the at least a portion of the webpage via a visual recognition system.

5. The computer-implemented method of claim 4, further comprising:
providing one or more suggestions for similar webpage components based upon, at least in part, visually recognizing the webpage component associated with the selected portion of the webpage.

6. The computer-implemented method of claim 1, wherein extracting code associated with the selected portion of the webpage includes extracting markup code associated with the selected portion of the webpage.

7. The computer-implemented method of claim 1, wherein monitoring the network traffic associated with the selected portion of the webpage includes monitoring one or more server-side requests and one or more server-side responses associated with the selected portion of the webpage.

8. A computer program product comprising a non-transitory computer readable storage medium having a plurality of instructions stored thereon, which, when executed by a processor, cause the processor to perform operations comprising:
receiving a selection of at least a portion of a webpage;
extracting code associated with the selected portion of the webpage;
monitoring network traffic associated with the selected portion of the webpage; and
generating one or more webpage components based upon, at least in part, the extracted code and the monitored network traffic associated with the selected portion of the webpage.

9. The computer program product of claim 8, wherein receiving the selection of the at least a portion of the webpage includes:
selecting the at least a portion of the webpage; and
dragging the selected portion of the webpage to a droppable area within a user interface.

10. The computer program product of claim 8, wherein receiving the selection of the at least a portion of the webpage includes receiving architectural information associated with one or more webpage components.

11. The computer program product of claim 8, further comprising:
visually recognizing a webpage component associated with the at least a portion of the webpage via a visual recognition system.

12. The computer program product of claim 11, further comprising instructions for:
providing one or more suggestions for similar webpage components based upon, at least in part, visually recognizing the webpage component associated with the selected portion of the webpage.

13. The computer program product of claim 8, wherein extracting code associated with the selected portion of the webpage includes extracting markup code associated with the selected portion of the webpage.

14. The computer program product of claim 8, wherein monitoring the network traffic associated with the selected portion of the webpage includes monitoring one or more server-side requests and one or more server-side responses associated with the selected portion of the webpage.

15. A computing system including one or more processors and one or more memories configured to perform operations comprising:
receiving a selection of at least a portion of a webpage;
extracting code associated with the selected portion of the webpage;
monitoring network traffic associated with the selected portion of the webpage; and
generating one or more webpage components based upon, at least in part, the extracted code and the monitored network traffic associated with the selected portion of the webpage.

16. The computing system of claim 15, wherein receiving the selection of the at least a portion of the webpage includes:
selecting the at least a portion of the webpage; and
dragging the selected portion of the webpage to a droppable area within a user interface.

17. The computing system of claim 15, wherein receiving the selection of the at least a portion of the webpage includes receiving architectural information associated with one or more webpage components.

18. The computing system of claim 15, further comprising:
visually recognizing a webpage component associated with the at least a portion of the webpage via a visual recognition system.

19. The computing system of claim 18, wherein the operations further comprise:
providing one or more suggestions for similar webpage components based upon, at least in part, visually recognizing the webpage component associated with the selected portion of the webpage.

20. The computing system of claim 15, wherein extracting code associated with the selected portion of the webpage includes extracting markup code associated with the selected portion of the webpage.
